(19) United States
(12) Patent Application Publication
(10) Pub. No.: US 2011/0018304 A1
(43) Pub. Date: Jan. 27, 2011

(54) SYSTEM FOR INCREASING A FIELD OF VIEW OF A USER OF A VEHICLE

(75) Inventor: Stephen F. Burns, Huntertown, IN (US)

Correspondence Address: International Truck Intellectual Property Company,, 4201 WINFIELD ROAD, WARRENVILLE, IL, 60555, US

(73) Assignee: International Truck Intellectual Property Company LLC, Warrenville, IL (US)

(21) Appl. No.: 12/508,707

(22) Filed: Jul. 24, 2009

(51) Int. Cl. B60J 3/00; B60R 1/10; B60J 1/02

(52) U.S. Cl. 296/97.5

(57) ABSTRACT

Embodiments described herein provide a system for increasing a field of view of a substantially stationary user of a vehicle having a ground facing surface. In one embodiment, the system comprises one side of the field of view defined by a substantially level gaze of the substantially stationary user. A windshield is disposed at a nose of the vehicle. A visor is disposed on the vehicle. The visor is positioned such that the windshield is between the ground facing surface of the vehicle and the visor. The visor has a ground facing surface. A vehicle mirror is disposed on the ground facing surface of the visor. A line of sight extends from the vehicle mirror to ground. A second side of the field of view is defined by the line of sight.

### BACKGROUND

Embodiments described herein relate to a system for increasing a field of view of a user of a vehicle. More specifically, embodiments disclosed herein relate to a mirror disposed on a visor on a truck that increases a field of view of a substantially stationary user of the truck.

A vehicle 10 provides a substantially stationary user 12 of the vehicle 10 with a field of view directed toward a nose 16 of the vehicle 10. The substantially stationary user 12 is seated in a cab of the vehicle 10 and this is the position of the substantially stationary user while using the vehicle 10. Substantially stationary means that the user 12 does not change his seated position in the cab of the vehicle 10. An ordinary field of view is shown in FIG. 1. This ordinary field of view is defined by an area between lines A and A′. One side of the ordinary field of view, represented by line A, is defined by a substantially level gaze of the substantially stationary user 12, and the other side, represented by line A′, is defined by a line extending between the substantially stationary user and an end 13 of a windshield 14. It is to be recognized that an area between line A′ and the nose 16 of the vehicle 10 represents a “blind spot” where vision of the substantially stationary user 12 is limited. It is desirable to reduce the “blind spot” thereby increasing a field of view of the substantially stationary user 12.

### SUMMARY

Embodiments described herein provide a system for increasing a field of view of a substantially stationary user of a vehicle having a ground facing surface. In one embodiment, the system comprises one side of the field of view defined by a substantially level gaze of the substantially stationary user. A windshield is disposed at a nose of the vehicle. A visor is disposed on the vehicle. The visor is positioned such that the windshield is between the ground facing surface of the vehicle and the visor. The visor has a ground facing surface. A vehicle mirror is disposed on the ground facing surface of the visor. A line of sight extends from the vehicle mirror to ground. A second side of the field of view is defined by the line of sight.

### DESCRIPTION OF THE DRAWINGS

FIG. 1 is a generic depiction of fields of view provided to a substantially stationary user by a vehicle;

FIG. 2 is a sectional view of a vehicle mirror described herein applied to a visor of the vehicle;

FIG. 3 is a perspective view of a vehicle mirror shown in FIG. 2; and

FIG. 4 is an exploded view of the vehicle mirror described herein associated with a visor.

### DETAILED DESCRIPTION

Embodiments described herein relate to a system for increasing a field of view of view of a substantially stationary user 12 of a vehicle 10. In one embodiment, the system comprises a vehicle mirror 18 that increases a field of view of a substantially stationary user 12 of the vehicle 10 while the substantially stationary user 12 uses the vehicle 10. More specifically, embodiments disclosed herein relate to a vehicle mirror 18 disposed on a visor 20 disposed on a vehicle 10. The visor 20 is positioned on the vehicle 10 such that the windshield 14 is between a ground facing surface 11 of the vehicle 10 and the visor 20. While, for the sake of clarity of understanding, the vehicle mirror 18 is disclosed with respect to use of the vehicle mirror 18 with a truck, it is to be understood that the vehicle mirror 18 can be used with any vehicle 10, such as an automobile, an air plane, a train and the like.

In one embodiment, the vehicle 10 includes the visor 20 disposed adjacent the windshield 14 to block light from reaching the substantially stationary user 12. The visor 20 can protect the substantially stationary user 12 from glare of incident light, such as light from the sun. The visor 20 is attached to the vehicle 10 by suitable means well know in the art. The visor 20 may be of any suitable construction, such as hollow, solid, frame and the like, and provides a member 22 for accepting a portion of the vehicle mirror 18. Appropriate embodiments may be manufactured by any suitable process from any suitable material or materials. For example, embodiments may be made comprising a Resin Transfer Mold (RTM) process, a process using a Sheet Molding Compound (SMC), an injection molding process, a sheet metal stamping process and the like.

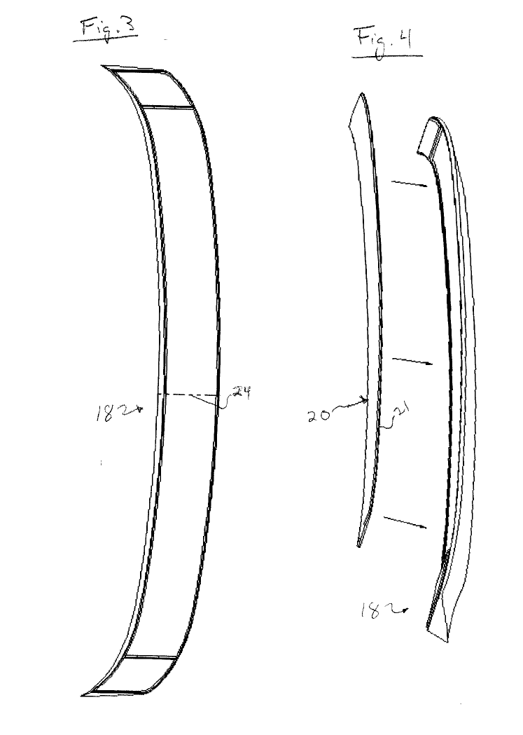

In one embodiment, the vehicle mirror 18 is substantially convex shaped and occupies or overlies substantially an entire ground facing surface 21 of the visor 20 as shown in FIGS. 3 and 4. In some embodiments, the vehicle mirror 18 may be made of conventional glass mirroring, injection molded acrylic or the like. The substantially convex shaped vehicle mirror 18 is shielded from glare of incident light by the visor 20 and has a reduced risk of sending a focused reflection to the substantially stationary user 12.

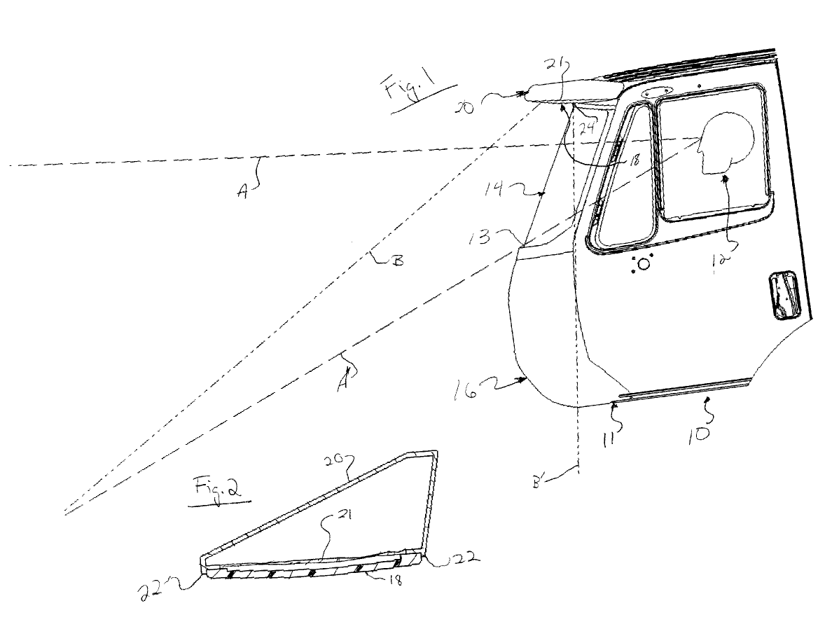

A line of sight B′, shown in FIG. 1, extends from a location proximate to a midpoint 24 of the vehicle mirror 18 to ground. The vehicle mirror 18 provides a substantially panoramic view of an area between lines B and B′ to the substantially stationary user 12. As shown in FIG. 1, the vehicle mirror 18 increases a field of view of the substantially stationary user 12 by adding a supplemental field of view, defined by an area between lines A′ and B′, to the ordinary field of view, defined by an area between lines A and A′. The vehicle mirror 18 provides the substantially stationary user 12 with an enhanced field of view, defined by an area between lines A and B′. In this manner, the “blind spot” is reduced.

What is claimed is:

1. A system for increasing a field of view of a substantially stationary user of a vehicle, the vehicle having a ground facing surface, the system comprising;
(a) one side of the field of view defined by a substantially level gaze of the substantially stationary user;
(b) a windshield disposed at a nose of the vehicle;
(c) a visor disposed on the vehicle, the visor being positioned such that the windshield is between the ground facing surface of the vehicle and the visor, the visor having a ground facing surface;
(d) a vehicle mirror disposed on the ground facing surface of the visor;
(e) a line of sight extending from the vehicle mirror to ground; and
(f) a second side of the field of view defined by the line of sight.

2. The system as defined in claim 1 wherein the vehicle is one of an automobile, an air plane, a train and a truck.

3. The system as defined in claim 1 wherein the visor is positioned on the vehicle such that the visor blocks light from reaching the substantially stationary user.

4. The system as defined in claim 1 wherein the vehicle mirror is substantially convex shaped.

5. The system as defined in claim 1 wherein the vehicle mirror overlies substantially all of the ground facing surface of the visor.

6. The system as defined in claim 1 wherein the vehicle mirror provides a substantially panoramic view to the substantially stationary user.
